(19) United States
(12) Patent Application Publication
(10) Pub. No.: US 2009/0313831 A1
(43) Pub. Date: Dec. 24, 2009

(54) HAND-HELD CIRCULAR SAW, IN PARTICULAR PLUNGE-CUT SAW

(75) Inventor: Chetan Patel, North Oaks, MN (US)

Correspondence Address: SCHWEGMAN, LUNDBERG & WOESSNER, P.A., P.O. BOX 2938, MINNEAPOLIS, MN, 55402, US

(73) Assignee: Scientific Molding Corporation Ltd., Somerset, WI (US)

(21) Appl. No.: 12/556,239

(22) Filed: Sep. 9, 2009

Related U.S. Application Data
(62) Division of application No. 11/569,745, filed on Sep. 24, 2007.
(60) Provisional application No. 60/575,721, filed on May 28, 2004.

(51) Int. Cl. B27B 9/02; B27B 9/04; B23D 45/16; B27G 19/04

(52) U.S. Cl. 30/123; 30/377; 30/391; 83/520; 83/522.15; 362/119

(57) ABSTRACT

A power saw including a body housing enclosing a motor, a saw blade operatively coupled to the motor, and a cutting head at least partially covering the saw blade, wherein the cutting head is rotatable relative to the body housing and is configured to be set relative to the body housing in at least two different fixed positions.

### CROSS-REFERENCE TO RELATED APPLICATION

This application is a Divisional of U.S. application Ser. No. 11/569,745, filed on Sep. 24, 2007, which is a U.S. National Stage Filing under 35 U.S.C. 371 from International Application Number PCT/US2005/019041, filed May 31, 2005 and published in English as WO 2005/118195 A3 on Dec. 15, 2005, which claims the benefit under 35 U.S.C. 119 (e) of U.S. Provisional Application No. 60/575,721, filed May 28, 2004, which applications and publication are hereby incorporated by reference in their entirety.

### FIELD

The invention relates generally to power tools, and more specifically to a circular saw.

### BACKGROUND

Traditional circular saws are large and bulky and operate with a motor which turns an output shaft which is perpendicularly positioned to the blade and blade guard assembly. The saw is controlled by a main handle that is positioned perpendicular to the output shaft of the motor. When not operating, the blade's cutting surface is concealed by a fixed blade guard over the top of the tool's base, and a movable spring-loaded guard below the base that rotates to expose the blade as the cut is made. This feature makes it awkward to plunge cut (cutting within a work piece rather than beginning from the edge of that piece).

### BRIEF DESCRIPTION OF THE DRAWINGS

FIG. 1 shows a side view of a saw according to one embodiment.

FIG. 2 shows another side view of the saw of FIG. 1.

FIG. 3 shows another side view of the saw of FIG. 1.

FIG. 4 shows a perspective view of a portion of the saw of FIG. 1.

FIG. 5 shows a partial cut-away view of the saw of FIG. 1.

FIG. 6, shows a partial cut-away view of the saw of FIG. 1.

FIG. 7 shows a perspective view of a portion of the saw of FIG. 1.

FIG. 8 shows a cut-away view of a portion of the saw of FIG. 1.

FIG. 9 shows a partial cut-away view of the saw of FIG. 1.

FIG. 10 shows a perspective view of the saw of FIG. 1.

FIG. 11 shows a perspective view of the saw of FIG. 1.

FIG. 12 shows a perspective view of the saw of FIG. 1.

FIG. 13 shows an accessory for a saw, in accordance with one embodiment.

FIG. 14 shows another view of the accessory of FIG. 13.

FIG. 15 shows an accessory for a saw, in accordance with one embodiment.

FIG. 16 shows an accessory for a saw, in accordance with one embodiment.

FIG. 17 shows another view of the accessory of FIG. 16.

FIG. 18 shows a perspective view of a saw, in accordance with one embodiment.

FIG. 19 shows a side view of a saw, in accordance with one embodiment.

FIG. 20 shows another side view of the saw of FIG. 19.

FIG. 21 shows a perspective view of the saw of FIG. 19.

FIG. 22 shows a perspective view of a guard lock of the saw of FIG. 19, in accordance with one embodiment.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined or that other embodiments may be utilized and that structural changes may be made without departing from the spirit and scope of the present invention. The following detailed description is, therefore, not to be taken in a limiting sense, and the scope of the present invention is defined by the appended claims and their equivalents.

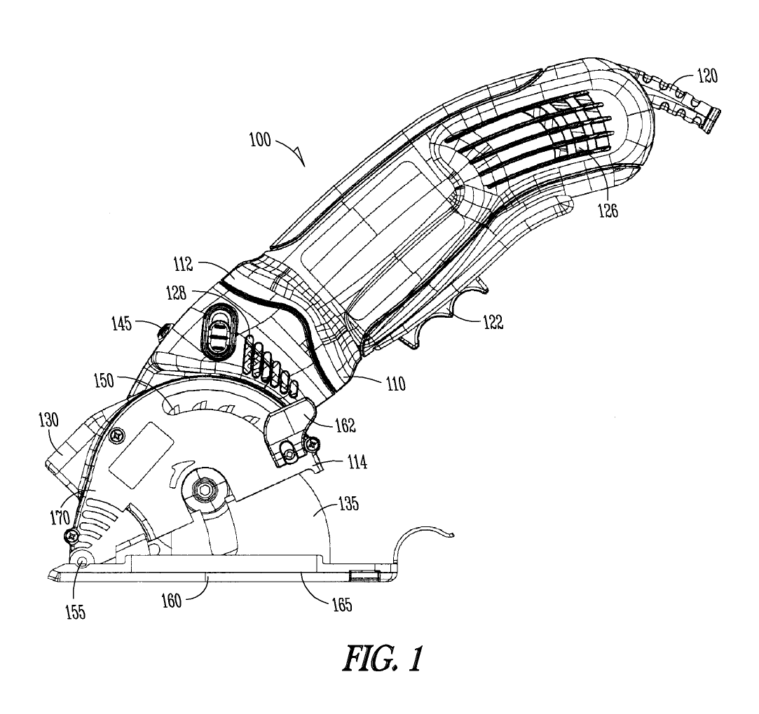

FIG. 1 shows a side view of a circular saw 100, in accordance with one embodiment. Saw 100 is a multi-purpose compact saw and generally includes a housing 110 which includes a body housing 112 and a cutting head 114.

Body housing 112 can include a plastic molded housing and encloses a motor which is connected to a power cord 120 which is connectable to an AC power source. In some embodiments, the motor can run off of battery power. Body housing 112 includes switch 122 to activate the saw. One or more vents 126, 128 can be formed in body housing 112 for cooling of the motor. The design of saw 100 incorporates a motor which is mounted within the body housing 112 of the tool, and a series of gears which cause a circular blade to operate in a parallel orientation to the motor's output shaft. This enables a much smaller overall tool.

Saw 100 is dimensioned to be hand-held. A user grips body housing 112 and activates switch 122. In some examples, the grip is designed for leveraging the tool in the cutting direction. Additionally, soft grip features can be incorporated for aesthetic reasons as well operator comfort and to reduce fatigue. In one example, the body housing 112 is made of Nylon 6 and the cutting head 114 is a cast magnesium w/metal base attached. The overmold is santoprene, but can be relatively high durometer (75A-85A) to resist wear and dirt impregnation, and can be resistant to hand acids, and petroleum based products.

Located on a front surface of cutting head 114 is a light housing 130. Light housing 130 can include a laser cutting guide and an LED light for illumination, and which can be activated by a switch 145. Further details will be discussed below.

A circular blade 150 is coupled to body housing 112 with cutting head 114 enclosing the blade. Cutting head 114 fully surrounds saw blade 150, when not in use. Cutting head 114 includes an upper guard 170 that covers the upper surface of the saw blade and a lower cutting base 160. Cutting base 160 includes a cutting surface 165 and a guard portion 135 which partially surrounds and covers the lower portion of saw blade 150. Cutting base 160 is rotationally coupled to upper guard 170 of cutting head 114 at pivot point 155. A latch 162 is used to set the depth of cut. Cutting base 160 rotates upward exposing the saw blade until guard portion 135 of base 160 encounters latch 162.

In various examples, the body design allows the user to grip the tool body during normal use. The power/speed control switch 122 is centrally located to be convenient to either hand. For example, power switch 122 is located such that it can be activated with either hand and only require one-handed operation. A double action (trigger with secondary interlock) can be required however as a safety measure.

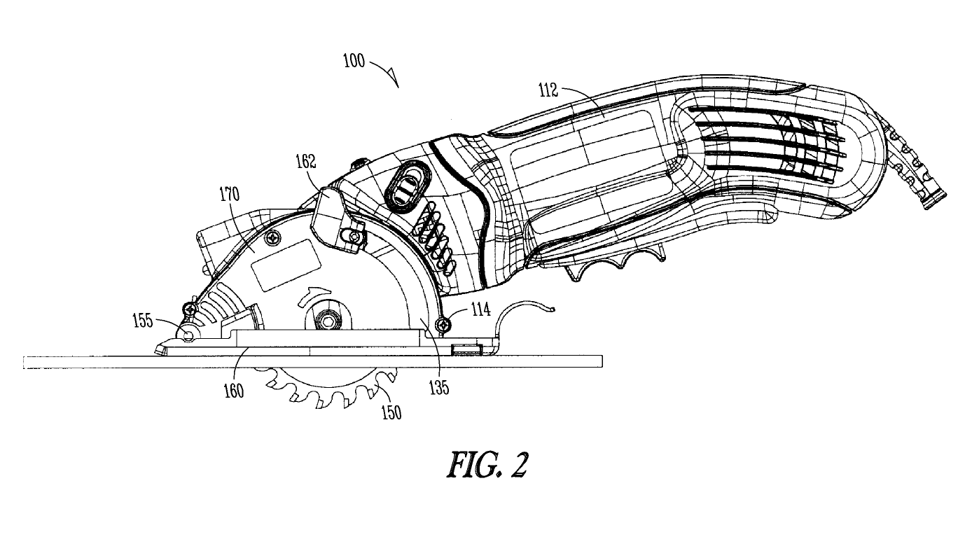

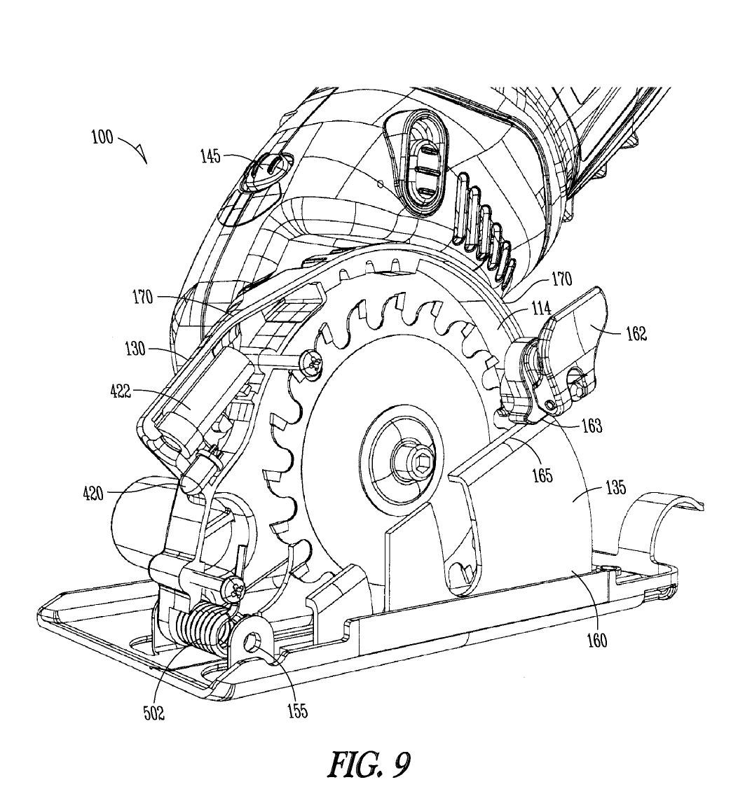

FIG. 2 shows saw 100 in use as cutting base 160 rotates up during a cut. Guard portion 135 of base 160 rotates upwards within upper guard 170 until guard portion 135 contacts latch 162. In this example, latch 162 is set at a full depth of cut. The cutting base 160 pivots from the front (nose) giving the operator visual queues that the tool is to be placed with the front (nose) in contact with the material with and then plunge by pivoting the tool downward. Referring also to FIG. 1, cutting head 114 conceals saw blade's 150 cutting surface fully above the cutting base 160 when not in use. The saw blade 150 is exposed during cutting by pushing the body of the tool down against base 160 against the tension of a resistant torsion spring 502 (FIG. 9) located between base 160 and upper guard 170. In this example, spring 902 is located at the pivot point 155. In other examples, the spring can be located anywhere along the area between base 160 and upper guard 170. Accordingly, as lower cutting base 160 rotates upward via pivot point 155, torsion spring 502 provides a bias to bias cutting base downward to cover saw 150.

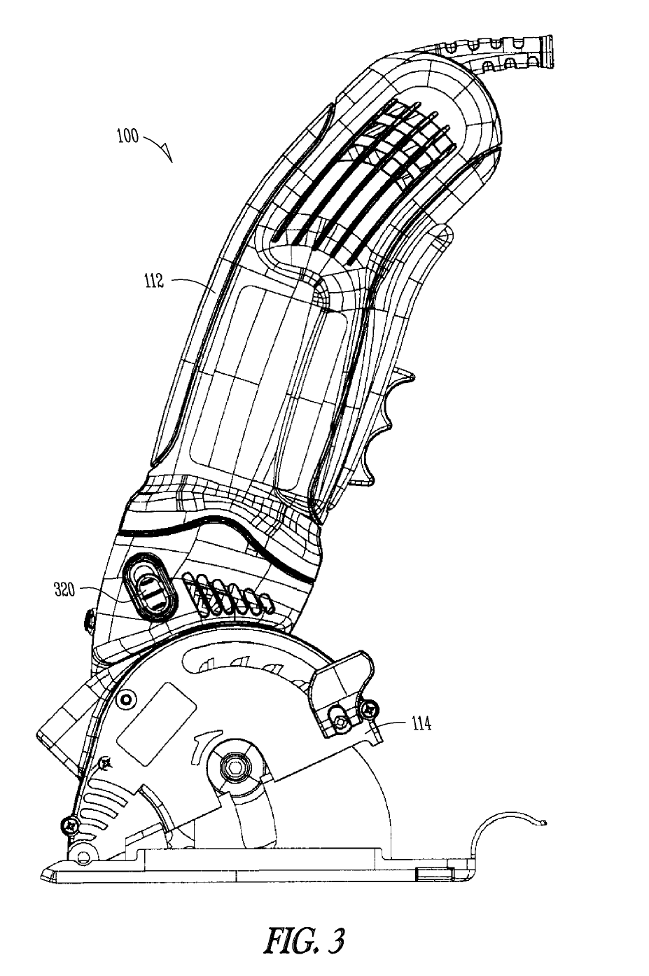

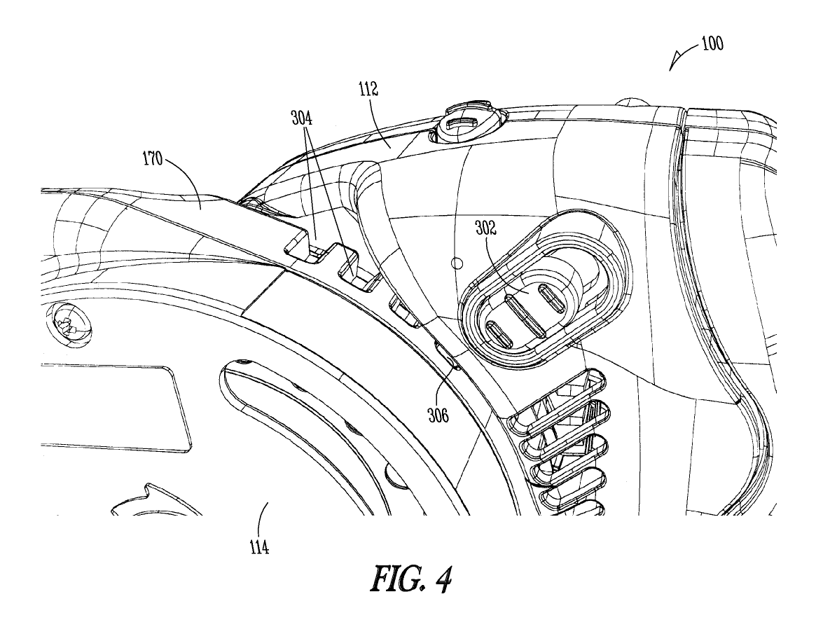

FIG. 3 shows another side view of saw 100. FIG. 4 shows a perspective view of a portion of saw 100. Referring also to FIG. 1, cutting head 114 is at least partially rotatable relative to body housing 112 allowing a user to set the angle between body housing 112 and cutting head 114 for comfort and for different cutting situations, such as floors, walls, or ceilings. Cutting head 114 is designed to pivot allowing the operator to select the preferred hand position when cutting. This feature will aide in creating the “hand shake” grip position to minimize fatigue and Carpal Tunnel Syndrome (“CTS”) risks. In some examples, the motion can be spring loaded but may also be manually locked in a fixed position(s).

For example, saw 100 can include a plurality of indentations 304 and an engaging member 306 that can selectively engage one of the plurality of indentations 304 so as to fix the position of the cutting head 114 relative to the body housing 112. This allows the rotating cutting head 114 to operate free-flowing within a limited range for ergonomic benefit, or be set in multiple fixed positions. For example, FIG. 3 shows body housing 112 rotated upwards relative to cutting head 114, while in FIG. 1 body housing 112 is set at a lower angle relative to cutting head 114.

In various embodiments, different number of indentations 304 can be provided. In one embodiment, indentations 304 are located and spaced along the upper surface of upper guard 170 of cutting head 114. Engaging member 306 can be a post or other protrusion for example. Engaging member 306 can be operatively coupled to an actuator 302 allowing a user to raise and lower the engaging member into a selected indentation 304 as they rotate upper guard 170 relative to housing 112.

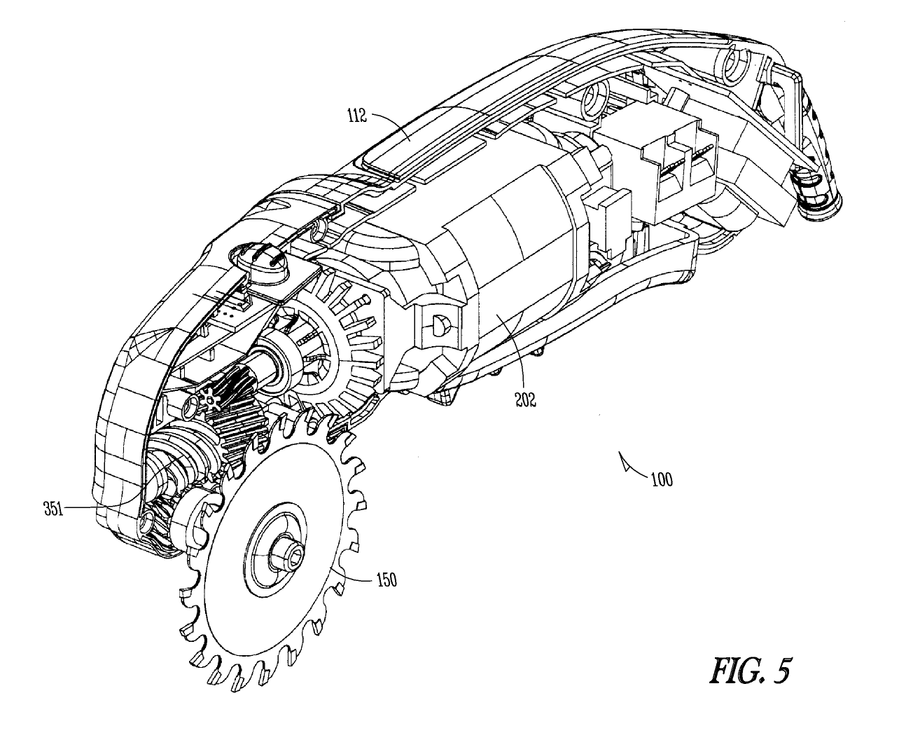

FIG. 5 shows schematically a portion of the inner mechanism of saw 100, in accordance with one embodiment. Saw 100 includes a motor 202 which engages a plurality of gears 351 to drive blade 150. The motor 202 can be a 120V Universal AC motor operating at 3.3 Amps rated or higher, with a no-load motor speed: 26,000-33,000 RPM. In this embodiment, motor 202 is mounted parallel to the longitudinal orientation of housing 112. The plurality of gears 351 cause blade 150 to operate in parallel to the motor's output shaft. In other words, the rotational axis of blade 150 is perpendicular to the rotational axis of the shaft of motor 202. Gears 351 can include a motor shaft gear, reduction gear, worm pinion, and worm gear. The bearings can be high speed bearings: for example, 32,250 RPM max for spindle bearings, and 37,500 RPM max for reduction shaft bearings, for example.

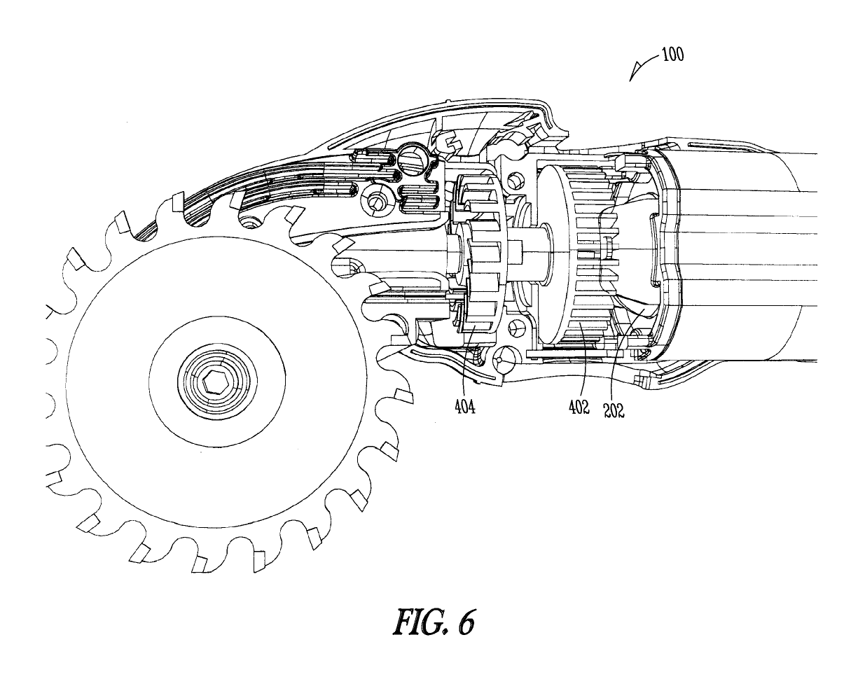

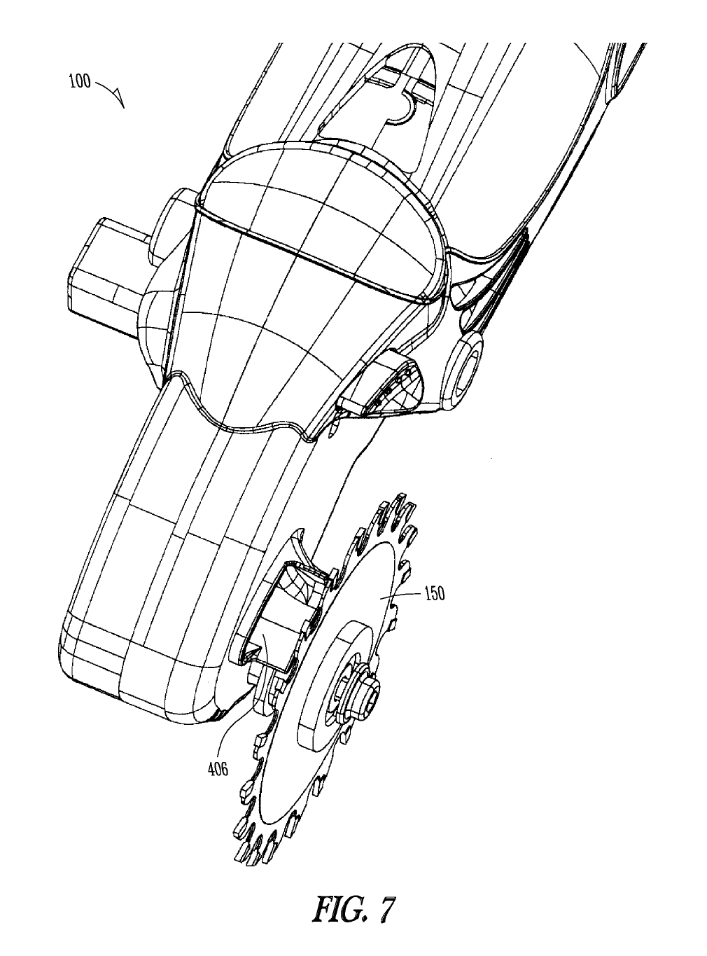

FIG. 6 shows a partial cut-away view of a portion of saw 100. FIG. 7 shows a perspective view of a front end of saw 100 with the cutting head removed for clarity. In one embodiment, motor 202 drives a cooling fan 402 and a fan 404 which draws sawdust into a channel 406 and out a sawdust port (not shown). In some embodiments, a dust collection bag can be used to collect dust from the dust exit port. Channel 406 is located behind saw blade 150 so as to collect dust during use. Fan 404 also cools the gear box area improving service life.

The saw 100 is designed for forced airflow via fan 402 near the motor shaft bearing and exhausting air through vents at the perimeter of the fan. The exhaust and intake vents are positioned such that the user will not block the airflow with the hand during normal operation.

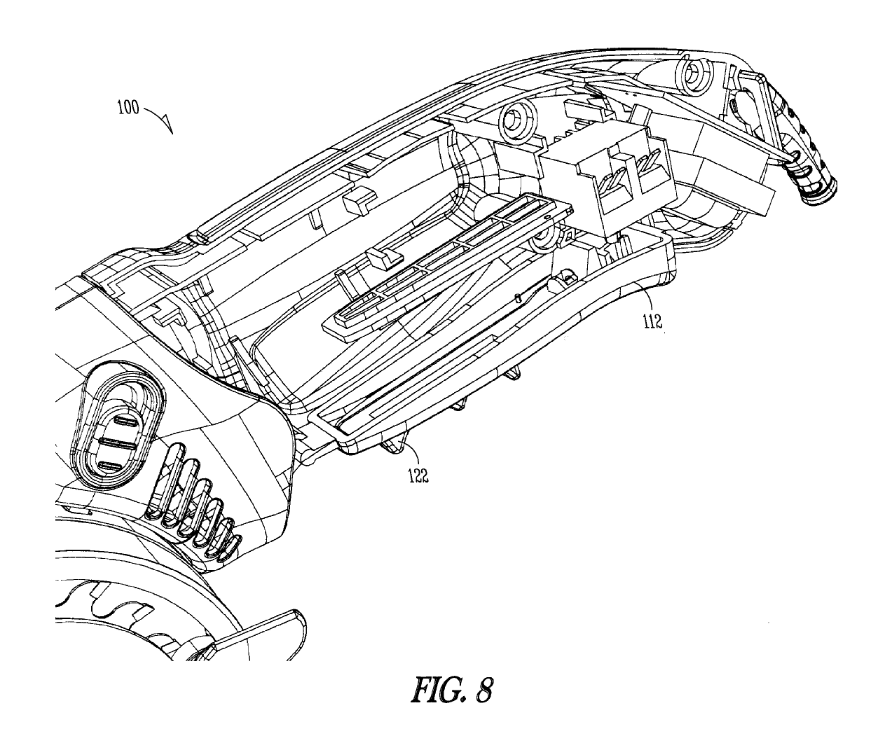

FIG. 8 shows a cut-away view of a portion of saw 100 showing details of switch 122, in accordance with one embodiment. In one embodiment, switch 122 includes a slide-action safety power trigger. Switch 122 operates such that the switch is first slid backwards towards the rear of saw 100 and then the switch is enabled to be depressed to activate the switch turning the tool ON. The switch 122 cannot be depressed when it is in its forward biased position. The switch can be spring-loaded to keep it biased forward.

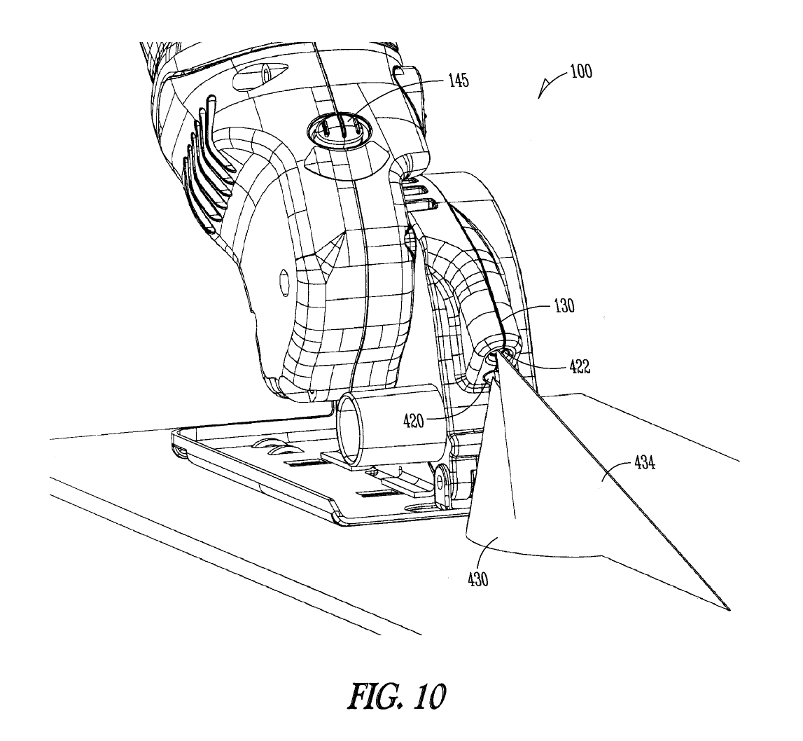

FIGS. 9 and 10 show operation of a light feature of saw 100, in accordance with one embodiment. Within housing 130 are an LED 420 and a laser 422, which can both be powered through the tools main power source, for example. LED 420 is positioned and angled so as to illuminate a diffuse area 430 in front of saw 100. Laser 422 is positioned and angled to provide a precise line of light 434 to indicate a cutting line of the saw blade of saw 100. In this example, both LED 420 and laser 422 are enclosed within housing 130 and mounted towards the front of upper guard 170 of cutting head 114. In other examples, the lights can be mounted separately or to different portions of the saw. In some example, one or both lights can be in a removable, battery-powered housing, for example.

In some examples, laser 422 can project a focused line 0″ to 6″-12″ in front of the cutting path. This will be used as an aide to keep the tool square to the cut line. The laser 422 can include a Wavelength and Class of 635-650 nm, Class IIIa. A power switch 145 for the light(s) on the saw can have three positions: Off, Laser ON, Laser & LEDs ON. This may also be accomplished with a selector switch and an independent ON/OFF switch.

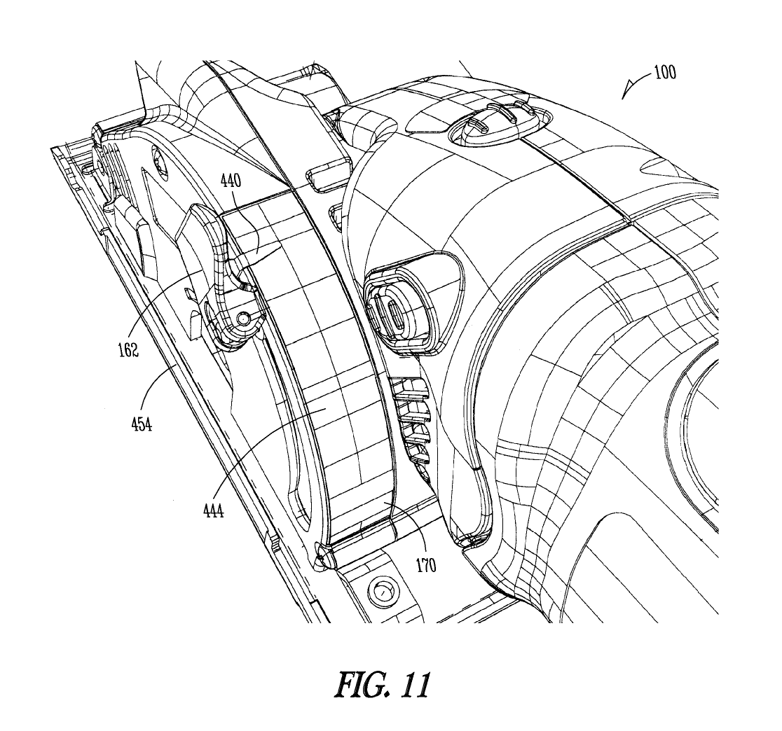

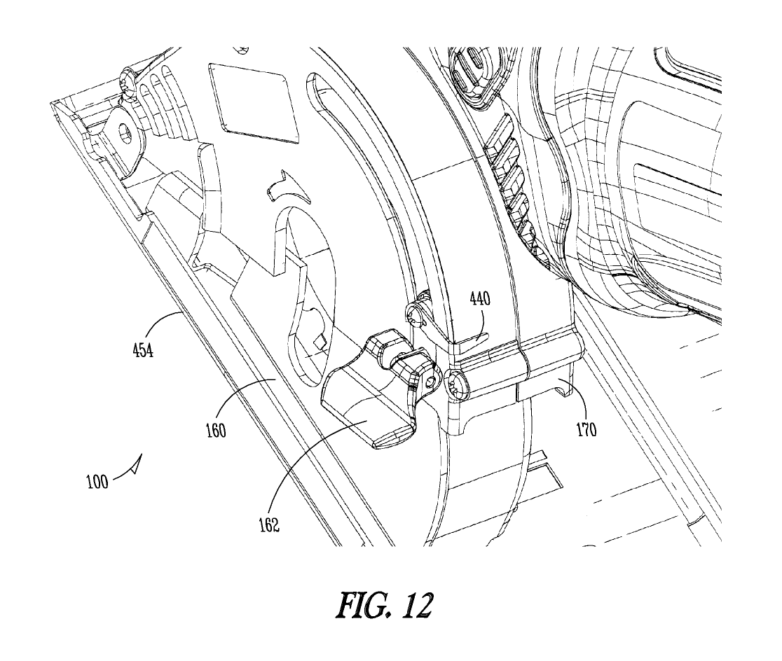

FIGS. 11 and 12 show a feature to set the cutting depth of saw 100. A depth indicator 440 slides along a top surface of upper guard 170 of cutting head 114. Depth indicator 440 can indicate both depth of cut as well as be used to determine the length of the initial plunge cut. Depth indicator 440 is operatively coupled to latch 162 and can be locked into place via latch 162 to enable the setting of a specific depth of cut as identified on an identifying measured scale 444. In one example, latch 162 flips in and out to latch and release, respectively, the latch, so as to move the latch to different locations along guard 170. Referring also to FIG. 9, latch 162 includes a bottom surface 163 that contacts a top surface 165 of guard 135 when guard 135 of cutting base 160 has rotated up enough relative to upper guard 170 to contact the latch 162.

In one embodiment, saw 100 also includes a length of cut indicator 454 marked on the base of the tool, which identifies the start and end points for the blade's exposure for the depth setting indicated by scale 444 as indicated by depth indicator 440. In use, a user refers to depth indicator 440 to ascertain the depth of cut on scale 444. Scale 454 corresponds to scale 444 such that by referring then to scale 454 the user can know the beginning and end points of an initial plunge cut, for example.

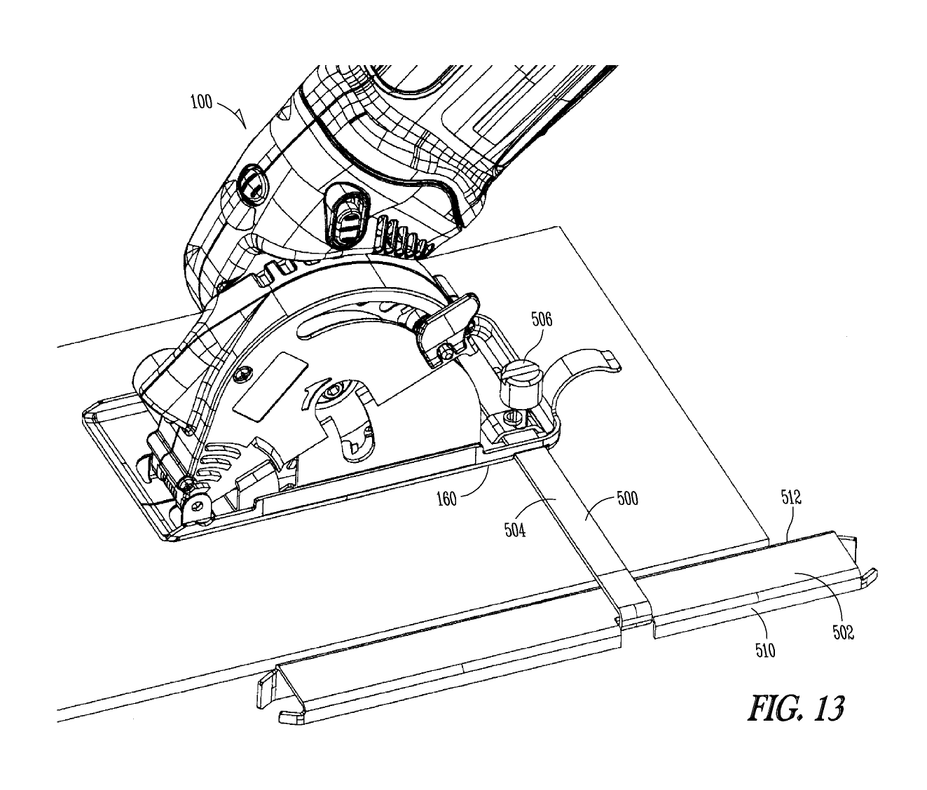

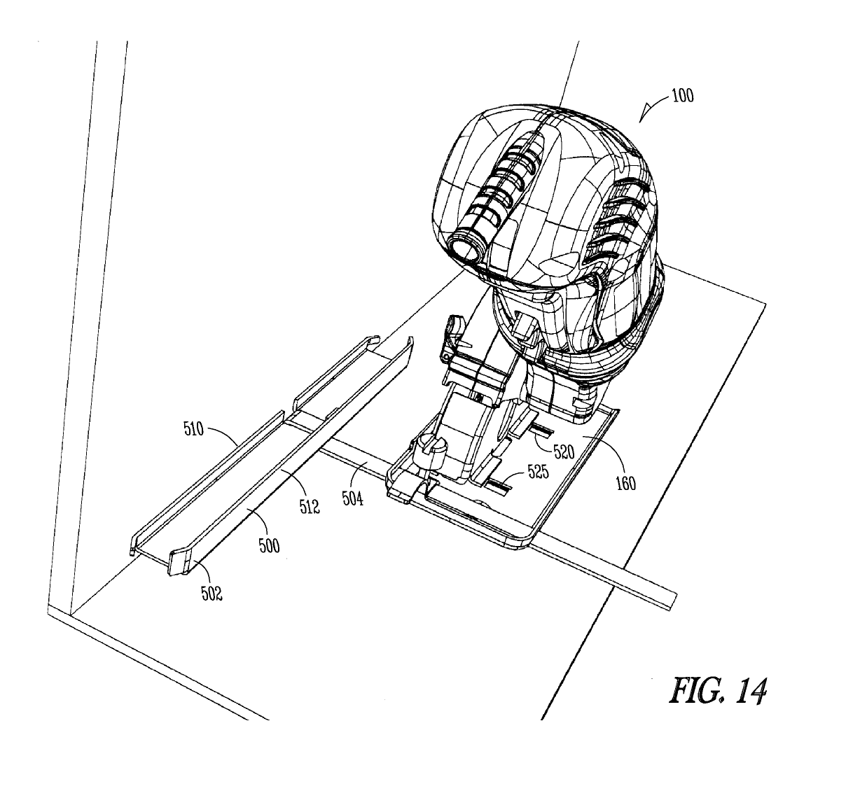

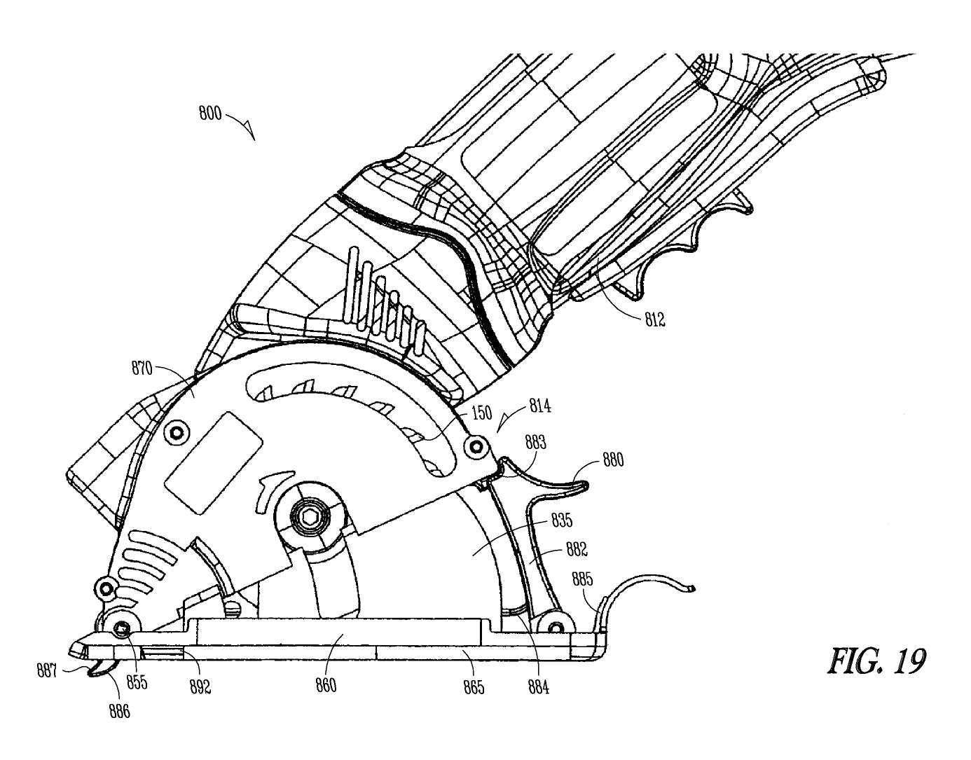

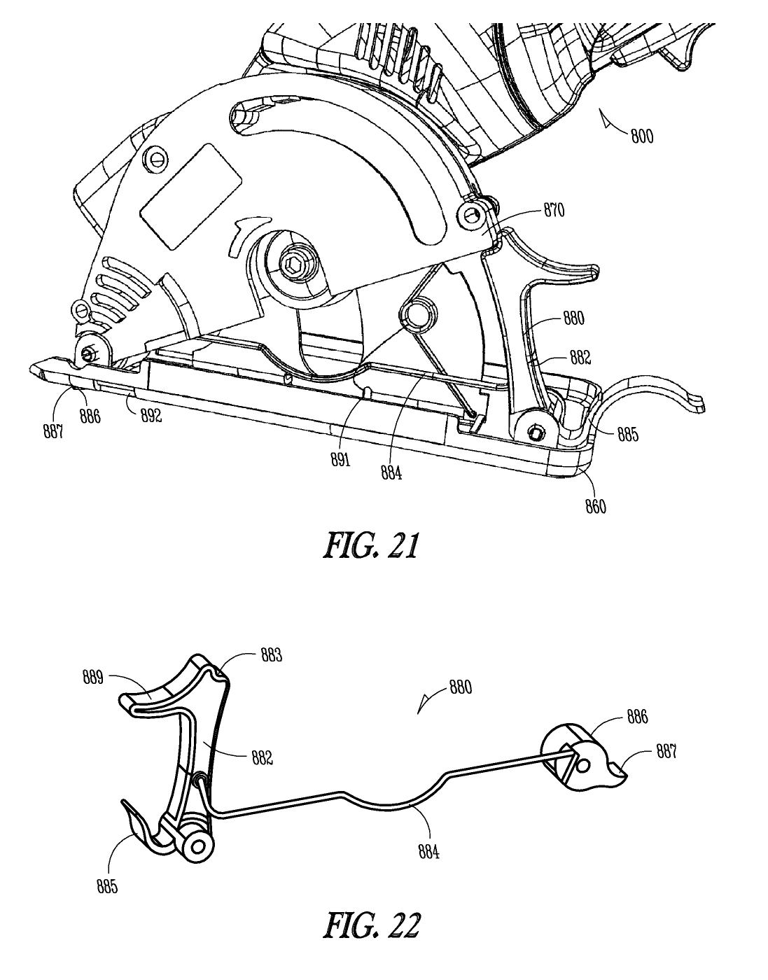

FIGS. 13 and 14 show a cutting guide member 500 for a saw 100, according to one embodiment. Cutting guide member 500 includes a straight edge member 502 attached perpendicularly to an arm 504. Arm 504 is removably couplable to the lower cutting base 160 using a screw 506, for example. In other embodiments, arm 504 can be coupled to a front area of the cutting base 160 (See slot 892 of FIGS. 19 and 21, for example). In one example, arm 504 can have an adjustment range of 0.0″-6″.

Straight edge member 502 is flat on both sides 510, 512 allowing both inside and outside cutting. This facilitates its use from the edge of a work piece (FIG. 13), or within a right angle interior cut, such as sliding the exterior guide surface along a wall, to make a cut in a floor (FIG. 14).

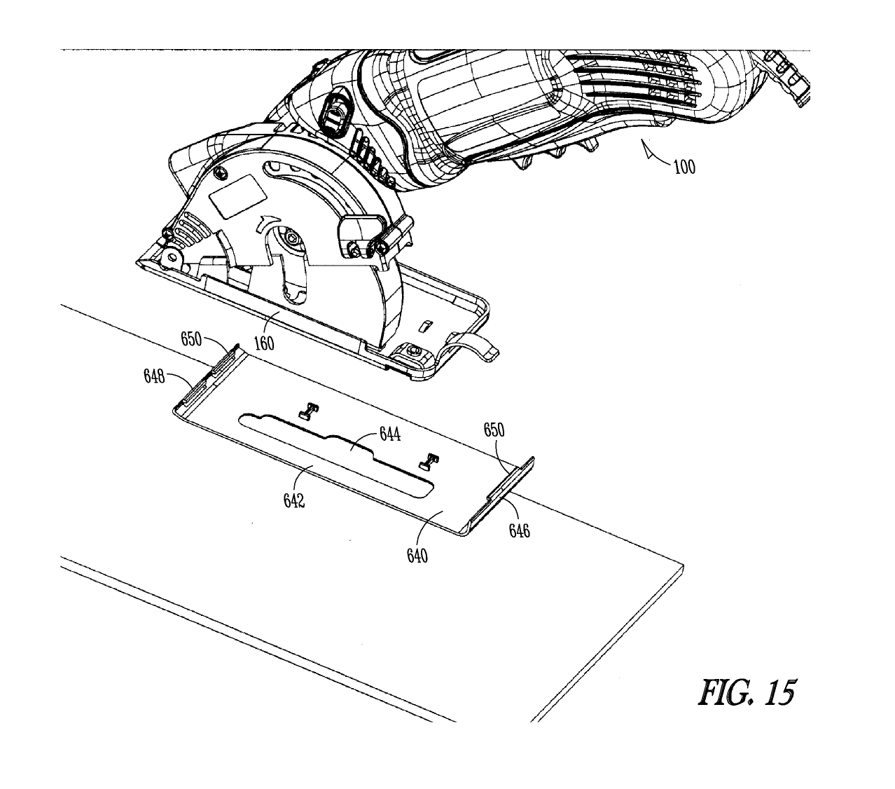

FIG. 15 shows a perspective view of an accessory 640 for saw 100, in accordance with one embodiment. Accessory 640 includes a member configured to reduce scratching of a work piece. Accessory 640 includes a generally planar body 642 having a slot 644 for the saw blade to go through. The front and back ends 646 and 648 include clips 650 to clip to a bottom surface of base 160 of saw 100. When accessory 640 is mounted it covers the bottom surface of base 160 and helps to eliminate/reduce scratching and scuffing of the work piece.

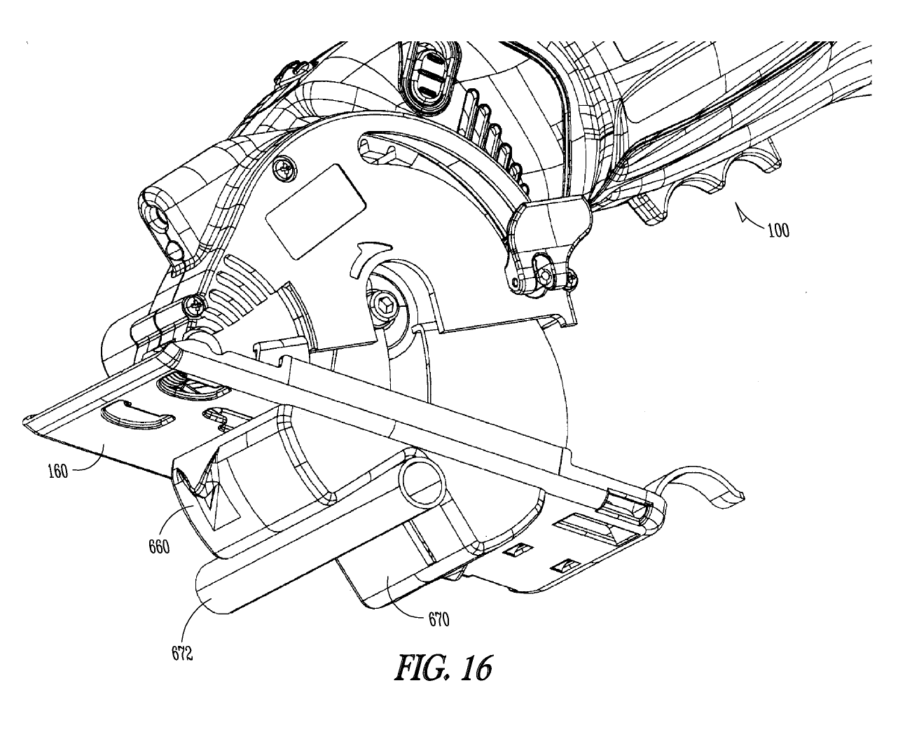

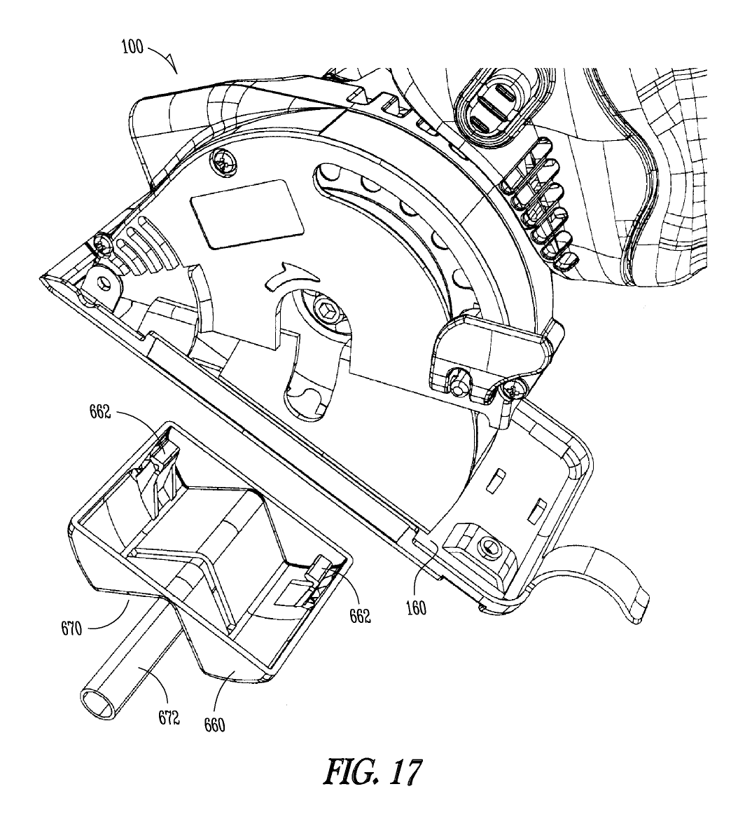

FIGS. 16 and 17 show views of an accessory 660, according to one embodiment. Accessory 660 includes one or more tabs 662 to mount to base 160 of saw 100. Base 160 can include corresponding mounting holes for the tabs 662. Accessory 660 includes an outer surface defining a V-shape 670. This facilitates cutting of round objects, such as pipe 672.

In other embodiments, other accessories can be provided for saw 100. Base 160 includes mounting holes (i.e. holes 520, 525 in FIG. 14), edges, and other mounting means, defining a mounting area for base 160, to allow a variety of accessories, such as accessories 500, 640, and 660 to be selectively mounted thereon.

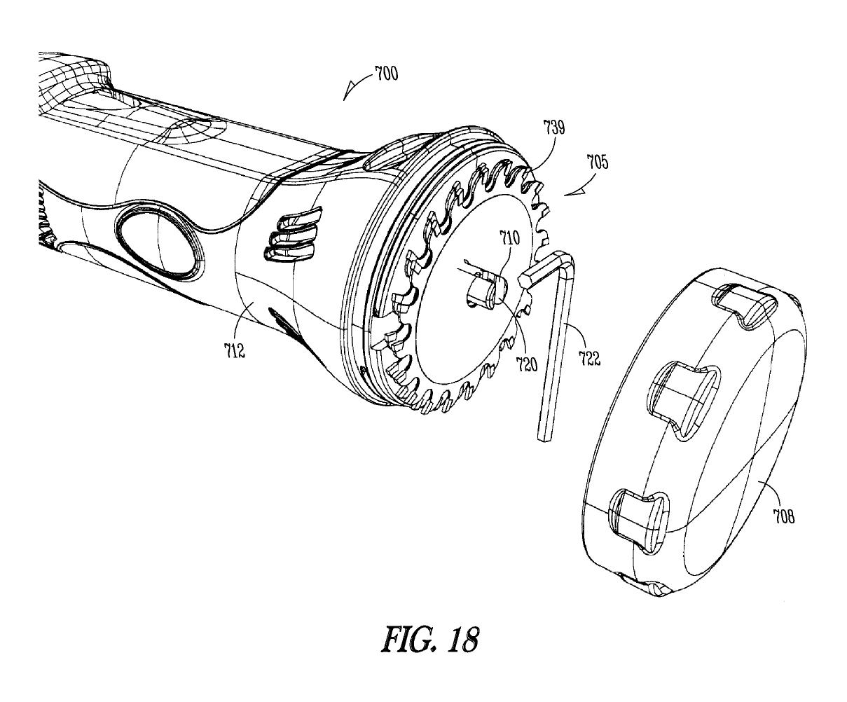

FIG. 18 shows a perspective view of a saw 700 according to one embodiment. Saw 700 can include any of the features discussed above for saw 100. Saw 700 includes a body 712 and a storage area 705 at an end of the body. A removable cap 708 threads over area 705. Blades and tools can be stored within a portion of the storage or within the cap, for example. A post 710 can be used to mount saw blades 739 with a notch 720 in the post to receive and hold a tool, such as Allen wrench 722.

FIG. 19 shows a side view of a saw 800, in accordance with one embodiment. Saw 800 can include any components of the saws discussed above, and certain details will be omitted for sake of clarity. Saw 800 generally includes a body housing 812 and a cutting head 814. A saw blade 150 is coupled to body housing 812 with cutting head 814 enclosing the blade. Cutting head 814 fully surrounds saw blade 150, when not in use. Cutting head 814 includes an upper guard 870 that covers the upper surface of the saw blade and a lower cutting base 860. Cutting base 860 includes a cutting surface 865 and a guard portion 835 which partially surrounds and covers the lower portion of saw blade 150. Cutting base 860 is rotationally coupled to upper guard 870 of cutting head 814 at pivot point 855.

In one embodiment, saw 800 includes a guard lock mechanism 880. Guard lock mechanism 880 acts to keep cutting base 860 from rotating toward upper guard 870 and exposing saw blade 150 when the saw is not in use.

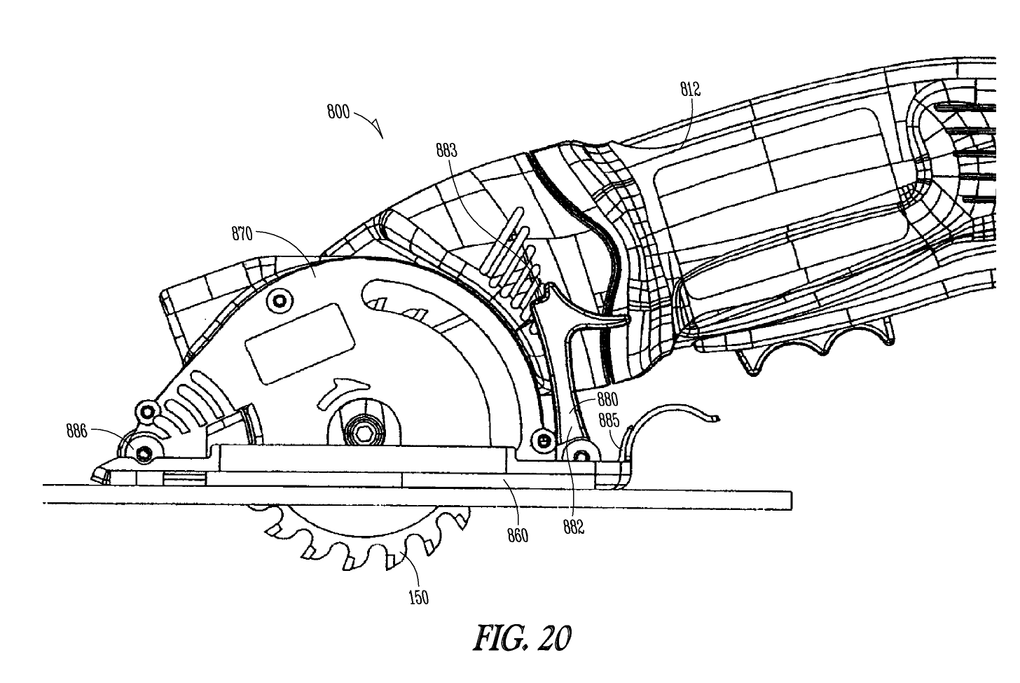

Referring also to FIGS. 20, 21, and 22, guard lock mechanism 880 includes a lock member 882 that is rotationally coupled to cutting base 860 and biased towards a front of the saw (in the position of FIG. 19) by a tail 885. Guard lock mechanism 880 further includes a linkage 884 that is coupled to lock member 882 and extends to an actuator 886. Actuator 886 is rotationally mounted at or near pivot point 855 of saw 800. In use, as saw 100 is placed onto a surface of a work piece, a tongue 887 of actuator 886 contacts the work piece and rotates actuator 886 (clockwise, relative to FIGS. 19-21). Tongue 887 rotates out of the way and pushes, via linkage 884, lock member 882 backwards. This releases upper guard 870 from contact with an upper shoulder 883 of lock member 882. Once released (FIG. 20), cutting base 860 can rotate upwards towards upper guard 870, exposing saw blade 150. When the saw is removed from the work piece, tail 885 pushes lock member 882 and actuator 886 (via linkage 884) back to their biased positions with lock member 882 holding upper guard 870 and cutting base 860 apart, such that the cutting base 860 cannot rotate upward. Lock member 882 can also include a projection 889 to manually control the lock member. In other examples, lock member 882 can be biased forward by springs, for example, or actuator 886 can be spring-loaded to pull the lock member 882 forward.

As can also be seen in FIG. 21, in this example, a spring 891 between upper guard 870 and cutting base 860 is located near a rear portion of the two members.

In various embodiments, the saws discussed above can include a mini circular saw designed to be very portable and lightweight. The saw can include a pivoting head design allowing convenient use while kneeling, standing, or working overhead. Tools and blades can be stored on-board, in some embodiments. The blade guard allows blade changing without removing the guard. The guard incorporates a depth of cut and cut length indicator. The guard also allows for accessory attachment.

The tool can have optional right angle handle of a design that can be rotated for multiple angles/left or right hand use. Some examples include 2-speed control with out torque feedback with the speed control will be located remotely from the power switch.

In another embodiment, a saw can incorporate an interchangeable power head that will allow the tool to convert between a spiral saw to a mini-circular saw. For example, the power heads will automatically latch in-place when installed and be removable with a single release button. Other attachments such as a sander are possible as design enhancements. This tool will allow for additional accessories such as a flexshaft, plunge base, circle cutter, etc.

In use of the saws discussed above, the tools can be used to cut flooring. For example, wood flooring is typically ¾″ thick and is currently cut using circular saws in the 7″ to 5¼″ size category as well as chop saws, and table saws. Laminate flooring less than ½″ thick and as thin as ¼″ can be cut, and under floor pads can be cut as well, as an alternative to a utility knife. The saws can cut vinyl and vinyl tile as well as roofing materials, wood, vinyl, and aluminum siding, plywood, decking, chipboard, insulating board, cement board, countertop materials, ceramic wall tile, various sheet stick such as plexiglass, fiberglass, and acrylics, plenum & round pipes and can be used as an alternative to tin snips, jig saw, pneumatic nibblers, or hacksaw. Also for making cuts in thin flat metal/metal fabrication. It can be used for making full width and full length cuts in drywall, as well as cutting out utility boxes, light switch/outlet boxes, recessed vanity mirrors.

A safety grip interlock can be included. A shaft lock can be provided to help change the blades of the saw. To change a blade, a user presses the shaft lock to prevent the blade from turning and then unscrews the bolt holding the blade in place.

The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. An apparatus comprising:
a power saw including a body housing enclosing a motor;
a saw blade operatively coupled to the motor;
an LED operatively coupled to a front section of the power saw to illuminate an area in front of the power saw; and
a laser operatively coupled to a front section of the power saw to indicate a cutting line of the saw blade.

2. The apparatus of claim 1, wherein the LED and the laser are both enclosed in a light housing.

3. The apparatus of claim 1, including a cutting head at least partially covering the saw blade, wherein the LED and the laser are coupled to the cutting head.

4. The apparatus of claim 3, wherein the cutting head is rotatably coupled to the body housing.

5. The apparatus of claim 4, wherein the cutting head is configured to be set relative to the body housing in at least two different fixed positions.

6. The apparatus of claim 5, wherein the cutting head includes a plurality of indentations and the body housing includes an engaging member that can selectively engage one of the plurality of indentations so as to fix the position of the cutting head relative to the body housing.

7. The apparatus of claim 5, wherein the cutting head includes an upper guard rotationally coupled to the body housing and a lower cutting base, wherein the lower cutting base is rotationally coupled to the upper guard.

8. The apparatus of claim 7, wherein the lower cutting base is rotationally coupled to the upper guard at a pivot point proximate a front end of each of the lower cutting base and the upper guard.

9. The apparatus of claim 8, wherein the lower cutting base is biased to conceal a cutting surface of the saw blade above the cutting base, the cutting surface being exposed during cutting by pushing the body housing of the tool down such that the lower cutting base rotates upward.

10. The apparatus of claim 9, including a spring located between the lower cutting base and the upper guard.

11. The apparatus of claim 8, further comprising a guard lock mechanism including a lock member coupled to the lower cutting base and rotational between a first, locked position where the lock member keeps the lower cutting base from rotating upward and a second, released position where the lock member does not interfere with the lower cutting base from rotating upward.

12. The apparatus of claim 11, wherein the guard lock mechanism includes an actuator coupled to a front of the cutting base and a linkage connecting the actuator to the lock member.

13. The apparatus of claim 12, wherein the actuator includes a tongue which acts to rotate the actuator as the actuator is placed in contact with a work piece.

14. An apparatus comprising:
a power saw including a body housing enclosing a motor;
a saw blade operatively coupled to the motor;
a cutting head rotatably coupled to the body housing and at least partially covering the saw blade, wherein the cutting head includes an upper guard rotationally coupled to the body housing and a lower cutting base, wherein the lower cutting base is rotationally coupled to the upper guard at a pivot point proximate a front end of each of the lower cutting base and the upper guard;
an LED operatively coupled to a front section of the power saw to illuminate an area in front of the power saw; and
a laser operatively coupled to a front section of the power saw to indicate a cutting line of the saw blade.

15. The apparatus of claim 14, wherein the LED and the laser are both enclosed in a light housing.

16. The apparatus of claim 14, wherein the LED and the laser are coupled to the cutting head.

17. The apparatus of claim 14, wherein the cutting head is configured to be set relative to the body housing in at least two different fixed positions.

18. The apparatus of claim 17, wherein the cutting head includes a plurality of indentations and the body housing includes an engaging member that can selectively engage one of the plurality of indentations so as to fix the position of tile cutting head relative to the body housing.

19. The apparatus of claim 14, wherein the lower cutting base is biased to conceal a cutting surface of the saw blade above the cutting base, the cutting surface being exposed during cutting by pushing the body housing of the tool down such that the lower cutting base rotates upward.

20. The apparatus of claim 14, further comprising a guard lock mechanism including a lock member coupled to the lower cutting base and rotational between a first, locked position where the lock member keeps the lower cutting base from rotating upward and a second, released position where the lock member does not interfere with the lower cutting base from rotating upward.
